(19) United States
(12) Patent Application Publication
(10) Pub. No.: US 2013/0006394 A1
(43) Pub. Date: Jan. 3, 2013

(54) NUMERICAL CONTROL DEVICE AND NUMERICAL CONTROL METHOD

(75) Inventors: Yukihiro Iuchi, Chiyoda-ku (JP); Naoki Nakamura, Chiyoda-ku (JP); Tomonori Sato, Chiyoda-ku (JP)

(73) Assignee: MITSUBISHI ELECTRIC CORPORATION, Chiyoda-ku, Tokyo (JP)

(21) Appl. No.: 13/634,463

(22) PCT Filed: Mar. 24, 2010
(86) PCT No.: PCT/JP2010/002051

§ 371 Date: Sep. 12, 2012

(51) Int. Cl. G05B 19/18

(52) U.S. Cl. 700/56

(57) ABSTRACT

The invention provides a numerical control device of a machine tool including linear and rotation axes, for controlling position and attitude of a tool with respect to a workpiece, the device comprising: an indexing-method decision unit that decides=one of a rotation indexing method of operating only the rotation axis and a tool-tip-position holding indexing method of operating the rotation axis and linear axis and holding a tool tip position with respect to the workpiece, based on a commanded rotation axis, a commanded rotation direction of the commanded rotation axis, and the tool position; a moving-amount calculation unit that calculates moving amount of the axes based on the commanded rotation axis, the commanded rotation direction of the commanded rotation axis, the tool position, and the indexing method decided; and an output unit that outputs a position command to a servo amplifier based on the moving amount calculated.

### FIELD

The present invention relates to a numerical control (NC) device and a numerical control method for executing numerical control over a multiaxis machine tool having a rotation axis.

### BACKGROUND

A conventional numerical control device that controls a multiaxis machine tool having a rotation axis performs machining on a workpiece after controlling (hereinafter, “indexing”) a tool attitude so that a tool is held perpendicular to a worked surface by rotating the rotation axis when the tool is not perpendicular to the worked surface (for example, Patent Literature 1).

As an indexing method, there are known two types of methods, that is, an indexing method for operating only a rotation axis (hereinafter, “rotation indexing method”) and another indexing method for holding the relative position of a tool tip to the workpiece while operating a rotation axis and a linear axis (hereinafter, “tool-tip-position holding indexing method”). FIG. 21 shows an example of the rotation indexing method. In FIG. 21, only a rotation axis 22 of a tool 21 is operated without operating a linear axis, thereby controlling the tool attitude so that the tool 21 is held perpendicular to a worked surface 27a of a workpiece 27. At this time, the relative position of a tool tip 21a to the workpiece 27 is not held. On the other hand, FIG. 22 shows an example of the tool-tip-position holding indexing method. In FIG. 22, the linear axis and the rotation axis 22 of the tool 21 are operated, thereby controlling the tool attitude so as to hold the relative position of the tool tip 21a to the workpiece 27 while setting the tool 21 to be perpendicular to the worked surface 27a of the workpiece 27.

Conventionally, an operator of the numerical control device makes selection of which method should be used to perform indexing based on a position of the workpiece and a position of the tool, the rotation indexing method or the tool-tip-position holding indexing method.

### CITATION LIST

### Patent Literature

Patent Literature 1: Japanese Patent Application Laid-open No. 07-334221

### SUMMARY

### Technical Problem

However, it is difficult for the operator to select one of the indexing methods while accurately grasping the possible interference between the workpiece and the tool because of a complicated operation performed by the multiaxis machine tool controlled by the numerical control device. Accordingly, the operator erroneously selects an indexing method, and this may cause a problem that the interference occurs.

### Solution to Problem

The present invention provides a numerical control device of a machine tool that includes linear axes and rotation axes, for controlling a position and an attitude of a tool with respect to a workpiece, the numerical control device comprising: an indexing-method decision unit that decides, as an indexing method, one of a rotation indexing method of operating only the rotation axis and a tool-tip-position holding indexing method of operating the rotation axis and the linear axis and holding a position of a tool tip with respect to the workpiece, based on a commanded rotation axis, a commanded rotation direction of the commanded rotation axis, and the position of the tool; a moving-amount calculation unit that calculates a moving amount of each of the axes based on the commanded rotation axis, the commanded rotation direction of the commanded rotation axis, the position of the tool, and the indexing method decided by the indexing-method decision unit; and an output unit that outputs a position command to a servo amplifier based on the moving amount calculated by the moving-amount calculation unit.

The present invention provides the numerical control device according to claim 1, wherein the indexing-method decision unit determines whether or not the workpiece or a table becomes closer to the tool when performing indexing in the rotation indexing method, decides the rotation indexing method as the indexing method when determining that the workpiece or the table does not become closer to the tool, and decides the tool-tip-position holding indexing method as the indexing method when determining that the workpiece or the table becomes closer to the tool.

### Advantageous Effects of Invention

According to the present invention, it is possible to obtain a numerical control device that selects an appropriate indexing method so as to avoid interference between a workpiece and a tool. This can suppress the interference between the workpiece and the tool. It is also possible for an operator of the numerical control device to efficiently perform his/her operations.

### BRIEF DESCRIPTION OF DRAWINGS

FIG. 1 is a block diagram showing a mechanical configuration of a numerical control device according to a first embodiment.

FIG. 2 is a functional block diagram showing functions of the numerical control device according to the first embodiment.

FIG. 3 is an external view of a machine tool according to the first embodiment.

FIG. 4 is a flowchart showing indexing-related processes performed by the numerical control device according to the first embodiment.

FIG. 5 is an illustration showing a case where a workpiece and a tool become closer to each other when a rotation indexing method is used.

FIG. 6 is an illustration showing a case where the workpiece and the tool become farther from each other when the rotation indexing method is used.

FIG. 7 is a functional block diagram showing functions of a numerical control device according to a development example of the first embodiment.

FIG. 8 is an explanatory illustration of a method of determining whether or not the workpiece and the tool become closer to each other when the rotation indexing method is used, based on a moving direction of a tool tip.

FIG. 9 is an external view of a machine tool according to a second embodiment.

FIG. 10 is a flowchart showing indexing-related processes performed by a numerical control device according to the second embodiment.

FIG. 11 is an explanatory illustration of a method of determining whether or not a table and a tool become closer to each other.

FIG. 12 is a functional block diagram showing functions of a numerical control device according to a third embodiment.

FIG. 13 is a flowchart showing indexing-related processes performed by the numerical control device according to the third embodiment.

FIG. 14 is an illustration showing loci of a tool tip according to the third embodiment.

FIG. 15 is an illustration showing loci of a tool tip according to a development example of the third embodiment.

FIG. 16 is a functional block diagram showing functions of a numerical control device according to a fourth embodiment.

FIG. 17 is a flowchart showing indexing-related processes performed by the numerical control device according to the fourth embodiment.

FIG. 18 explains indexing-related processes performed by the numerical control device.

FIG. 19 is an illustration showing a case where a workpiece interferes with a tool when a tool-tip-position holding indexing method is used.

FIG. 20 is an illustration showing a case where moving amounts of a moving-prohibited axis and a moving prohibiting direction are cleared in the case of FIG. 19.

FIG. 21 is an explanatory illustration of a rotation indexing method.

FIG. 22 is an explanatory illustration of a tool-tip-position holding indexing method.

### REFERENCE SIGNS LIST

2 INDEXING-METHOD DECISION UNIT
3 MOVING-AMOUNT CALCULATION UNIT
4 POSITION UPDATE UNIT
5 MOVING-AMOUNT OUTPUT UNIT
6 STROKE-OVER DETERMINATION UNIT
7 INTERPOLATION UNIT
20 MACHINE COORDINATE SYSTEM
21 TOOL
21a TOOL TIP
22 TOOL ROTATION AXIS
24 TOOL AXIS DIRECTION
25 TABLE
26 FIRST TABLE ROTATION AXIS
27 WORKPIECE
27a WORKED SURFACE
29 FEATURE COORDINATE SYSTEM
40 NUMERICAL CONTROL DEVICE
50 SERVO AMPLIFIER
61 MOVABLE RANGE
103 SECOND TABLE ROTATION AXIS
104 SECOND-TABLE-ROTATION-AXIS INTERLOCKED COORDINATE SYSTEM
105 BOUNDARY PLANE
110 MOVING-VELOCITY DECISION UNIT

### DESCRIPTION OF EMBODIMENTS

### First Embodiment

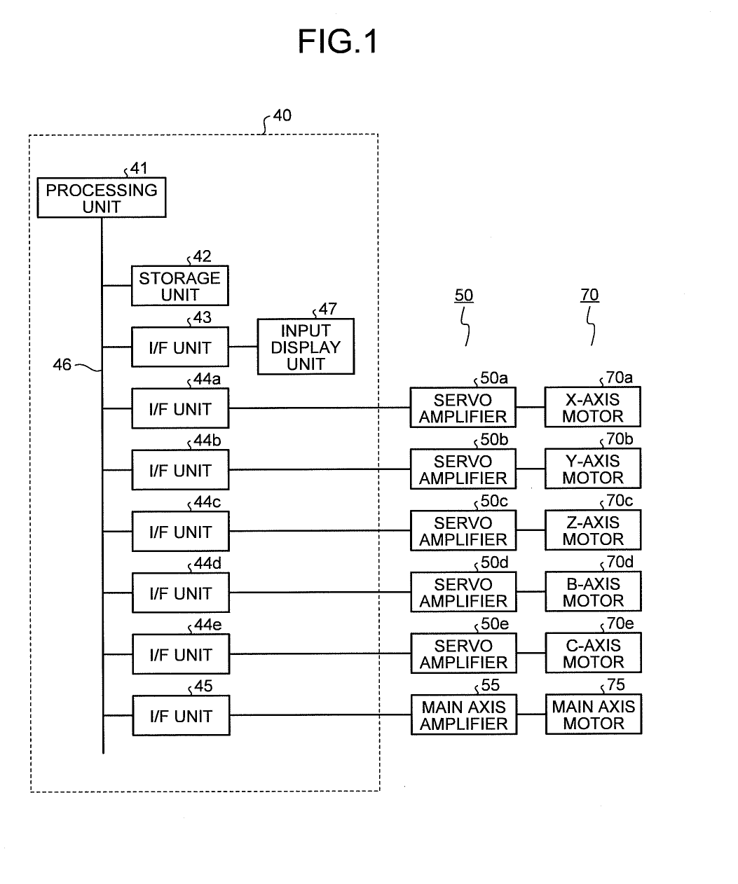

A first embodiment is explained with reference to FIGS. 1 to 8.

FIG. 1 is a block diagram showing a mechanical configuration of a numerical control device according to the first embodiment. A numerical control device 40 includes a processing unit 41 such as a central processing unit (CPU) and a storage unit 42 such as a read-only memory (ROM) or a random-access memory (RAM), which are connected by a bus 46. The storage unit 42 stores therein various data such as a system program and a machining program. The processing unit 41 executes the machining program according to the system program stored in the storage unit 42.

The numerical control device 40 also includes I/F unit 43, I/F units 44a to 44e and I/F units 45 that are connected to the bus 46, and an input display unit 47 that is connected to the I/F unit 43. The input display unit 47 includes a keyboard (not shown) used by a user to input the machining program, parameters and the like, and a display unit (not shown) for displaying the input machining program, parameters and the like. Servo amplifiers 50a to 50e are connected to the I/F units 44a to 44e, respectively. An X-axis motor 70a, a Y-axis motor 70b, a Z-axis motor 70c, a B-axis motor 70d and a C-axis motor 70e that are control targets of the servo amplifiers 50a to 50e are connected to the servo amplifiers 50a to 50e, respectively. A main axis amplifier 55 is connected to the I/F unit 45, and a main axis motor 75 that is a control target of the main axis amplifier 55 is connected to the main axis amplifier 55.

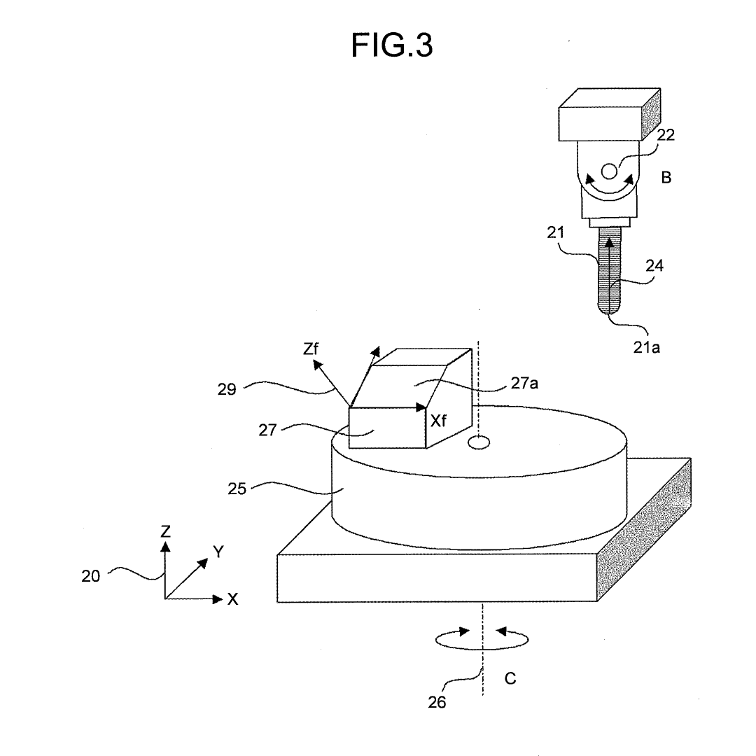

The X-axis motor 70a, the Y-axis motor 70b, the Z-axis motor 70c, the B-axis motor 70d, the C-axis motor 70e, and the main axis motor 75 drive a machine shown in FIG. 3 about an X-axis, a Y-axis, a Z-axis, a B-axis, a C-axis, and a main axis of a machine tool, respectively. In the present embodiment, the servo amplifiers 50a to 50e are comprehensively referred to as “servo amplifier 50”, and the X-axis motor 70a, the Y-axis motor 70b, the Z-axis motor 70c, the B-axis motor 70d, and the C-axis motor 70e are comprehensively referred to as “motor 70”.

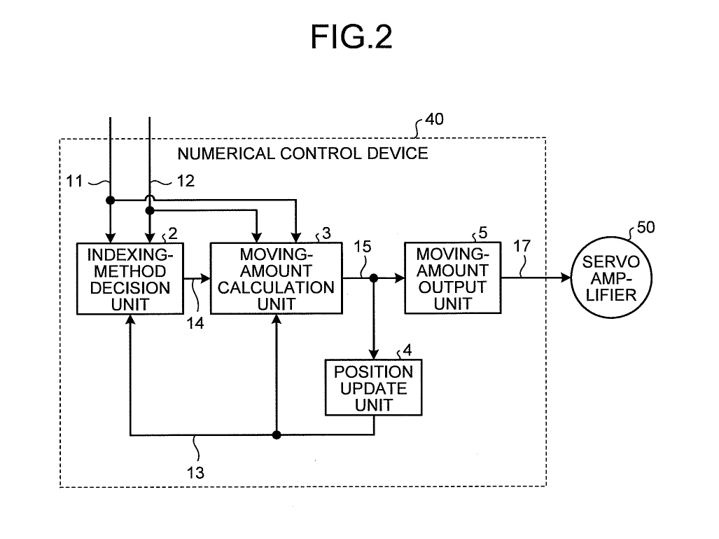

FIG. 2 is a functional block diagram showing functions of the numerical control device according to the first embodiment. The numerical control device includes an indexing-method decision unit 2, a moving-amount calculation unit 3, a position update unit 4, and a moving-amount output unit 5. Operations performed by these units are realized when the processing unit 41 shown in FIG. 1 executes the system program stored in the storage unit 42.

FIG. 3 is an external view of a machine tool according to the first embodiment. The machine tool shown in FIG. 3 is a so-called combinational type five-axis processing machine that has three linear axes, one table rotation axis, and one tool rotation axis. The tool is moved about the X-axis, Y-axis and Z-axis orthogonal to one another, and rotated about the tool rotation axis 22 that is the B-axis that serves as rotation about the Y-axis. A table 25 is rotated about a table rotation axis 26 that serves as rotation about the Z-axis. Reference sign 20 denotes a machine coordinate system that is stored in the machine tool in advance, 21a denotes a tool tip, 24 denotes a tool axis direction, 27 denotes a workpiece fixed on the table 25, 27a denotes a worked surface of the workpiece 27 inclined with respect to the C-axis, and 29 denotes a feature coordinate system defined by the worked surface 27a. The tool axis direction 24 is a direction from the tool tip 21a to an inside of the tool 21 along a central axis of the tool 21. The feature coordinate system 29 is constituted of an Xf-axis, a Yf-axis and a Zf-axis orthogonal to one another, and an origin thereof is defined at a predetermined position of the worked surface 27a. The Xf-axis and the Yf-axis are defined to be parallel to the worked surface 27a. The Zf-axis is defined to be orthogonal to the worked surface 27a and a positive direction thereof is defined as a direction outward from the workpiece 27.

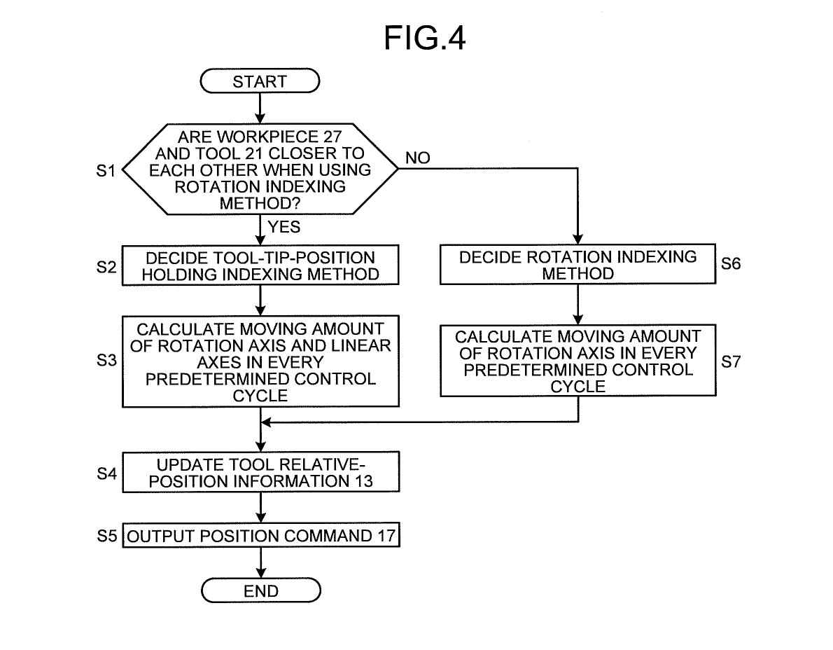

Indexing-related processes performed by the numerical control device 40 are described next with reference to FIG. 4. FIG. 4 is a flowchart showing indexing-related processes performed by the numerical control device according to the first embodiment. Note that indexing means that the positive direction of the Zf-axis of the feature coordinate system 29 shown in FIG. 3 is to be made to match the tool axis direction 24. In this case, it is unnecessary that the tool tip 21a is opposed to the worked surface 27a.

First, the indexing-method decision unit 2 determines whether or not the workpiece 27 is made closer to the tool 21 when using a rotation indexing method, based on rotation axis information 11, rotation direction information 12, and tool relative-position information 13 (S1). The rotation axis information 11 is information for identifying a rotation axis to be commanded, and in this embodiment, the information is assumed to identify the tool rotation axis 22. Therefore, the rotation indexing method according to the present embodiment means an indexing method in which only the tool rotation axis 22 is rotated. The rotation direction information 12 is information for identifying a positive direction or a negative direction as a rotation direction of the rotation axis to be commanded. The rotation axis information 11 and the rotation direction information 12 are inputted when an operator of the numerical control device 40 operates the input display unit 47 and stored in the storage unit 42. The tool relative-position information 13 is information for identifying a relative position of the tool 21 to the workpiece 27, and is a value calculated by the position update unit 4 as described later.

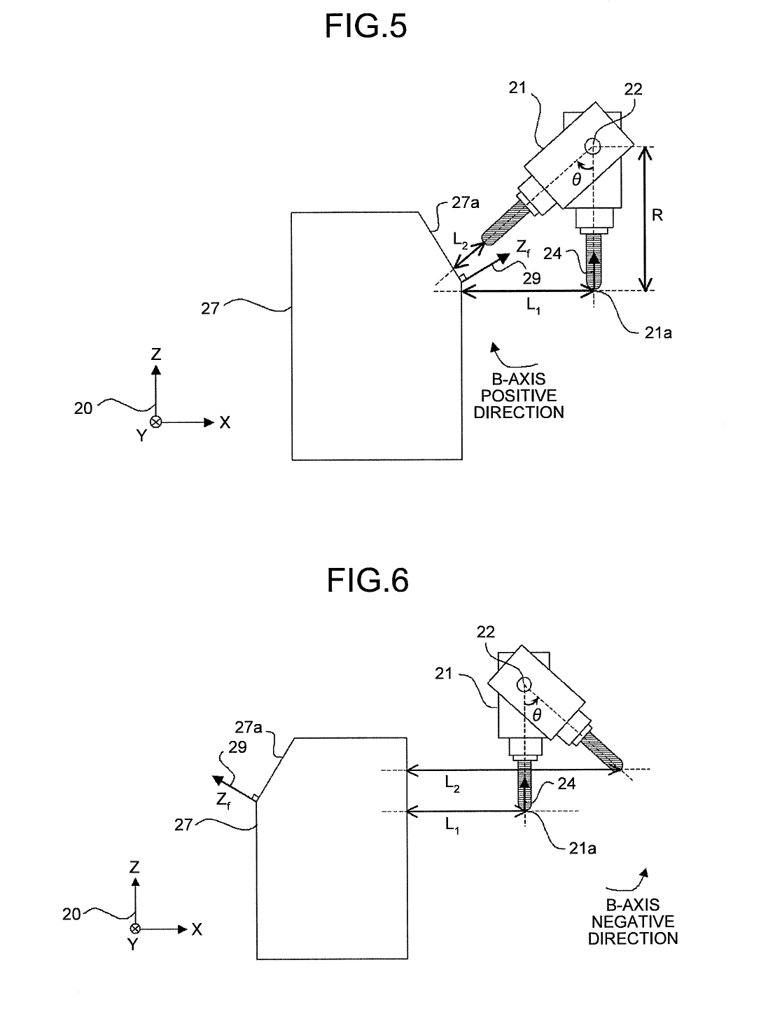

With reference to FIGS. 5 and 6, a method of determining whether or not the workpiece 27 and the tool 21 become closer to each other when the rotation indexing method is used. FIG. 5 is an illustration showing a case where the workpiece 27 and the tool 21 become closer to each other when the rotation indexing method is used. FIG. 6 is an illustration showing a case where the workpiece 27 and the tool 21 become farther from each other when the rotation indexing method is used. In the case of FIG. 5, it is necessary to rotate the tool rotation axis 22 in the positive direction (clockwise) so as to make the tool axis direction 24 match the positive direction of the Zf-axis of the feature coordinate system 29 because the worked surface 27a of the workpiece 27 is inclined in a lower right direction. Therefore, in the case of FIG. 5, the rotation direction information 12 identifies the positive direction. On the other hand, in the case of FIG. 6, it is necessary to rotate the tool rotation axis 22 in the negative direction (counterclockwise) so as to make the tool axis direction 24 match the Zf-axis direction of the feature coordinate system 29 because the worked surface 27a of the workpiece 27 is inclined in a lower left direction. Therefore, in the case of FIG. 6, the rotation direction information 12 identifies the negative direction.

First, the indexing-method decision unit 2 calculates a length L₁ between the workpiece 27 and the tool tip 21a before rotation of the tool rotation axis 22 and a length L₂ between the workpiece 27 and the tool tip 21a after rotation of the tool rotation axis 22 by an angle θ. The lengths L₁ and L₂ refer to lengths between the tool tip 21a and a surface of the workpiece 27 closest to the tool tip 21a before and after the rotation of the tool 21, respectively. The lengths L₁ and L₂ can be calculated based on, for instance, the tool relative-position information 13, the rotation direction information 12, the rotation angle θ, measurements of the workpiece 27, a central position of the tool rotation axis 22, a length R between a center of the tool rotation axis 22 and the tool tip 21a, and/or the like. An arbitrary value can be set to the rotation angle θ as long as the rotation angle θ satisfies 0<θ<180. The rotation angle θ, the measurements of the workpiece 27, the central position of the tool rotation axis 22, and the length R between the center of the tool rotation axis 22 and the tool tip 21a are stored in the storage unit 42 in advance.

At the time of calculating the lengths L₁ and L₂, positions on the machine coordinate system 20 corresponding to the tool tip 21a and a point on the surface of the workpiece 27 may be calculated, respectively, or a relative position of the tool tip 21a to the workpiece 27.

After calculating the lengths L₁ and L₂, the indexing-method decision unit 2 determines whether or not the lengths L₁ and L₂ satisfy L₁>L₂. When the lengths L₁ and L₂ satisfy L₁>L₂, the indexing-method decision unit 2 determines that the workpiece 27 and the tool 21 become closer to each other. When the lengths L₁ and L₂ satisfy L₁≦L₂, the indexing-method decision unit 2 determines that the workpiece 27 and the tool 21 are not closer to each other.

When determining at S1 that the workpiece 27 and the tool 21 become closer to each other, the indexing-method decision unit 2 decides a tool-tip-position holding indexing method and generates indexing method information 14 for identifying the decided indexing method (S2). The tool-tip-position holding indexing method in the present embodiment means an indexing method of operating the tool rotation axis 22 and the linear axes and holding the relative position of the tool tip 21a to the workpiece 27. Next, the moving-amount calculation unit 3 calculates a moving amount 15 of each of the tool rotation axis 22 and the linear axes in every predetermined control cycle based on the rotation axis information 11, the rotation direction information 12, the tool relative-position information 13, and the indexing method information 14 (S3). At this time, the moving-amount calculation unit 3 calculates the moving amount 15 such that the tool axis direction 24 matches the positive direction of the Zf-axis of the feature coordinate system 29 by operating the tool rotation axis 22 and the linear axes while fixing the relative position of the tool tip 21a to the workpiece 27.

The position update unit 4 accumulates the moving amount 15 in every predetermined control cycle calculated at S3, and adds the result of accumulation to the tool relative-position information 13 updated in an immediately previous cycle, so as to update the tool relative-position information 13 (S4). Meanwhile, the moving-amount output unit 5 outputs a position command 17 for each axis to the servo amplifier 50 based on the moving amount 13 calculated at step S3 (S5), and the numerical control device 40 then finishes the processing.

On the other hand, when determining at S1 that the workpiece 27 and the tool 21 do not become closer to each other, the indexing-method decision unit 2 decides the rotation indexing method (S6). The moving-amount calculation unit 3 calculates the moving amount 15 of the tool rotation axis 22 in every predetermined control cycle based on the rotation axis information 11, the rotation direction information 12, the tool relative-position information 13, and the indexing method information 14 (S7). At this time, the moving-amount calculation unit 3 calculates the moving amount 15 such that the tool axis direction 24 matches the positive direction of the Zf-axis of the feature coordinate system 29 by operating only the tool rotation axis 22. Thereafter, the numerical control device 40 proceeds to step S4.

In the first embodiment, the case where the rotation axis operated at the time of indexing is the tool rotation axis 22 has been described, but this is not limitation. That is, a table rotation axis 26 may be operated or both the tool rotation axis 22 and the table rotation axis 26 may be operated.

According to the first embodiment, it is possible to obtain the numerical control device that selects an appropriate indexing method for avoiding the interference between the workpiece and the tool. This can suppress the interference between the workpiece and the tool. It is also possible for an operator of the numerical control device to efficiently perform operations.

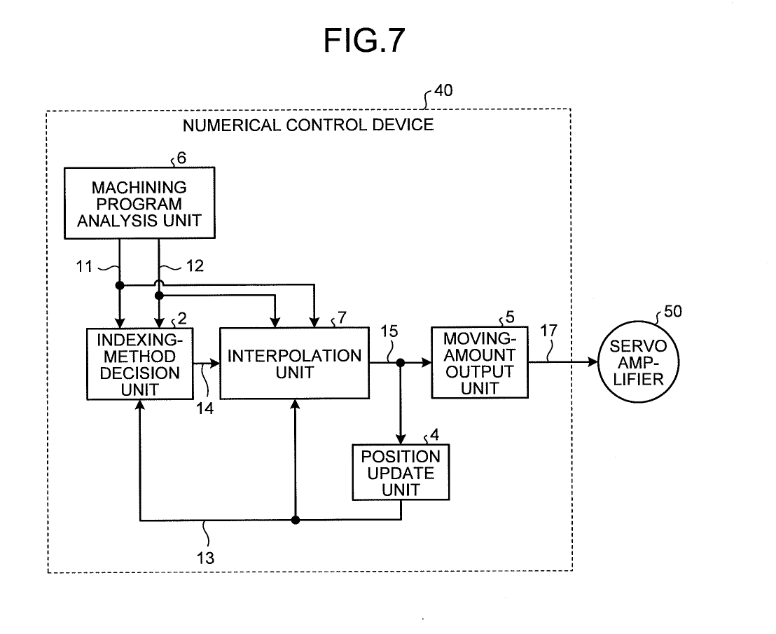

The numerical control device 40 according to the first embodiment shown in FIG. 2 is designed to operate in a manual operation mode executed when confirming the machining program, but this is not limitation. When the numerical control device 40 operates in an automatic operation mode based on the machining program stored in the storage unit 42, the numerical control device 40 is configured as indicated by a functional block diagram shown in FIG. 7. FIG. 7 is a functional block diagram showing functions of a numerical control device in a development example of the first embodiment, and corresponds to FIG. 2. In FIG. 7, the numerical control device 40 includes a machining-program analysis unit 6 that analyzes the machining program and generates the rotation axis information 11 and the rotation direction information 12. The numerical control device 40 also includes an interpolation unit 7 that calculates the moving amount 15 by an interpolation process in place of the moving-amount calculation unit 3. Even in the case shown in FIG. 7, it is possible to achieve advantageous effects equivalent to those of the first embodiment.

The machine tool according to the first embodiment shown in FIGS. 1 and 3 has been described to include the table rotation axis 26 and the tool rotation axis 22, but this is not limitation. That is, any configuration may be applied to the machine tool as long as the machine tool can control the tool axis direction with respect to the workpiece by use of a rotation axis.

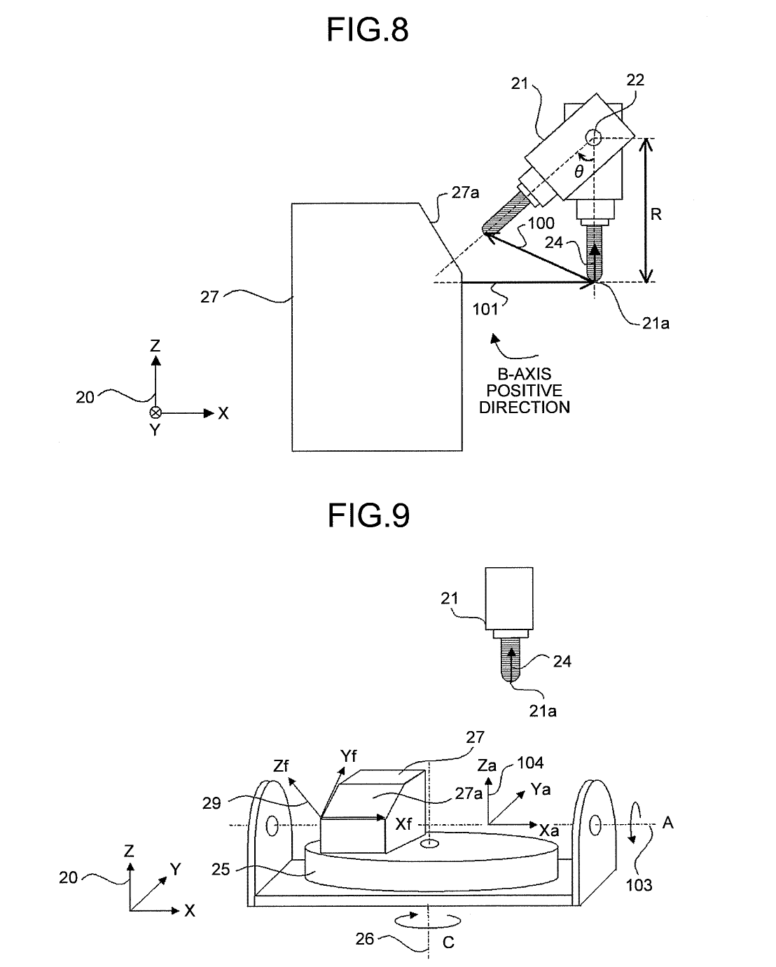

Furthermore, in the first embodiment, it is determined, based on change in the length between the workpiece 27 and the tool tip 21a before and after the rotation of the tool 21, whether or not the workpiece 27 and the tool tip 21a become closer to each other if the rotation indexing method is used, but this is not limitation. A development example of S1 shown in FIG. 4 is described with reference to FIG. 8. FIG. 8 is an explanatory diagram of a method of determining, based on moving direction of the tool tip 21a before and after the rotation of the tool 21, whether or not the workpiece 27 and the tool tip 21a become closer to each other if the rotation indexing method is used. FIG. 8 corresponds to FIG. 5. First, the indexing-method decision unit 2 calculates a difference between the position of the tool tip 21a before the rotation of the tool rotation axis 22 and the position of the tool tip 21a after the rotation of the tool rotation axis 22. The indexing-method decision unit 2 then obtains a moving direction 100 of the tool tip 21a based on the obtained difference in the position of the tool tip 21a and a position of the tool rotation axis 22 before the tool rotation axis 22 is subjected to rotation. The indexing-method decision unit 2 then compares a relative position direction 101 of the tool tip 21a to the workpiece 27 with the moving direction 100 before the rotation of the tool rotation axis 22 for each of directions of the X-, Y- and Z-linear axes, and determines whether or not the directions 100 and 101 are opposite to each other. When these directions are opposite for at least one of the linear axis directions, the indexing-method decision unit 2 determines that the workpiece 27 and the tool 21 become closer to each other. On the other hand, when these directions are not opposite for all the linear axis directions, the indexing-method decision unit 2 determines that the workpiece 27 and the tool 21 do not become closer to each other.

In an example of FIG. 8, it is possible to determine that the workpiece 27 and the tool 21 become closer to each other because the moving direction 100 of the tool tip 21a is opposite to the relative position direction 101 in an X-axis direction. In this way, it is possible to obtain the same effects as those of the first embodiment even when it is determined based on a moving direction of the tool tip whether or not the workpiece 27 and the tool 21 become closer to each other if the rotation indexing method is used.

### Second Embodiment

A second embodiment is explained with reference to FIGS. 9 to 11. In the following descriptions, elements different from those in the first embodiment are mainly explained.

FIG. 9 is an external view of a machine tool according to the second embodiment, and corresponds to FIG. 3. In the machine tool shown in FIG. 9, the tool 21 does not have a rotation axis, but the table 25 has the first table rotation axis 26 that is the C-axis and a second table rotation axis 103 that is the A-axis for rotation around the X-axis. Reference sign 104 denotes a second-table-rotation-axis interlocked coordinate system interlocked only with the second table rotation axis 103. The second-table-rotation-axis interlocked coordinate system 104 has an origin fixed to an arbitrary point on the second table rotation axis 103, and is constituted by linear axes of an Xa-axis, a Ya-axis and a Za-axis that are orthogonal to one another. A direction of the Xa-axis is equal to the X-axis direction of the machine coordinate system 20. Directions of the Ya-axis and the Za-axis when the second table rotation axis 103 is situated at an initial position are equal to a Y-axis direction and a Z-axis direction of the machine coordinate system 20, respectively, and the Ya-axis and the Za-axis are interlocked with rotation of the second table rotation axis 103. Furthermore, the first table rotation axis 26 rotates around the Za-axis of the second-table-rotation-axis interlocked coordinate system 104.

When the second table rotation axis 103 rotates, the table 25 operates in the Z-axis direction. Accordingly, there is a higher probability of the interference between the table 25 and the tool 21 than in the first embodiment. Therefore, in the second embodiment, the indexing method is decided depending on whether or not the table 25 becomes closer to the tool 21.

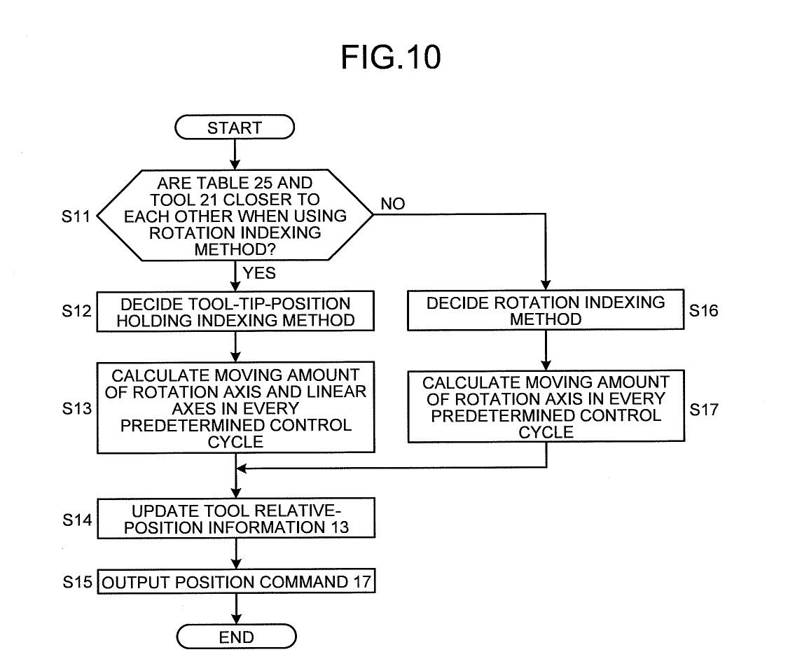

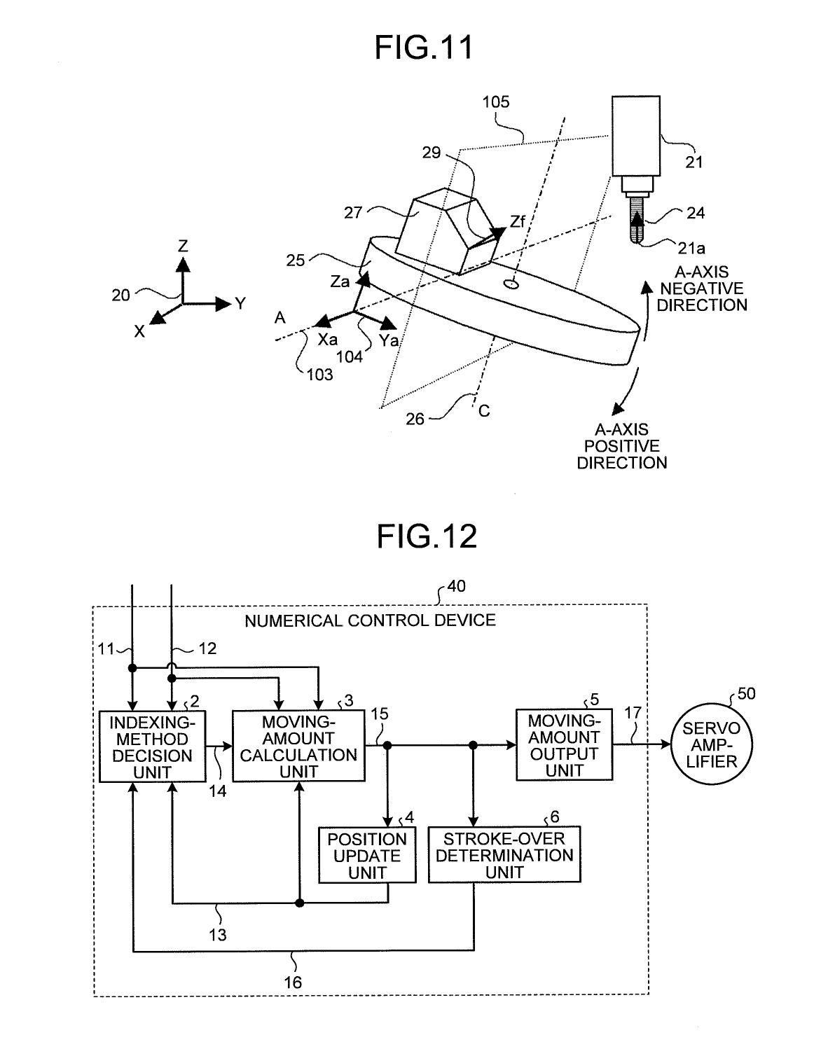

FIG. 10 is a flowchart showing indexing-related processes performed by the numerical control device according to the second embodiment, and corresponds to FIG. 4. FIG. 11 is an explanatory diagram of a method of determining whether or not the table 25 and the tool 21 become closer to each other. In FIG. 11, a boundary plane 105 is a plane that contains the Xa-axis and the Za-axis of the second-table-rotation-axis interlocked coordinate system 104. First, the indexing-method decision unit 2 determines whether the table 25 is made closer to the tool 21 when using the rotation indexing method, based on the rotation axis information 11, the rotation direction information 12, and the tool relative-position information 13 (S11). The rotation axis information 11 is assumed to be information for identifying the second table rotation axis 103 as a rotation axis to be commanded. Therefore, the rotation indexing method according to the present embodiment means an indexing method of operating only the second table rotation axis 103. The rotation direction information 12 is information for identifying a rotation direction of the second table rotation axis 103. The tool relative-position information 13 is information for identifying whether or not the tool tip 21a is at the right of the boundary plane 105, that is, whether or not a Ya coordinate of the tool tip 21a on the second-table-rotation-axis interlocked coordinate system 104 is positive, and is calculated by the position update unit 4 as described later.

The indexing-method decision unit 2 determines at S11 whether or not the Ya coordinate of the tool tip 21a on the second-table-rotation-axis interlocked coordinate system 104 is positive and whether or not the rotation direction of the second table rotation axis 103 is a positive direction (clockwise). When the Ya coordinate of the tool tip 21a is positive and the rotation direction of the second table rotation axis 103 is a negative direction, or when the Ya coordinate of the tool tip 21a is negative and the rotation direction of the second table rotation axis 103 is a positive direction, the indexing-method decision unit 2 determines that the table 25 and the tool 21 become closer to each other. Conversely, when the Ya coordinate of the tool tip 21a is positive and the rotation direction of the second table rotation axis 103 is the positive direction, or when the Ya coordinate of the tool tip 21a is negative and the rotation direction of the second table rotation axis 103 is the negative direction, the indexing-method decision unit 2 determines that the table 25 and the tool 21 do not become closer to each other.

In an example of FIG. 10, it is necessary to rotate the second table rotation axis 103 in the negative direction so as to make the tool axis direction 24 match the positive direction of the Zf-axis of the feature coordinate system 29 because the worked surface 27a of the workpiece 27 is inclined in the lower right direction. Therefore, the rotation direction information 12 identifies the negative direction. Accordingly, FIG. 10 represents a case where the table 25 and the tool 21 become closer to each other because the Ya coordinate of the tool tip 21a is positive and the rotation direction of the second table rotation axis 103 is the negative direction.

When determining at S11 that the table 25 and the tool 21 become closer to each other, the indexing-method decision unit 2 decides the tool-tip-position holding indexing method and generates indexing method information 14 for identifying the decided indexing method (S12). The tool-tip-position holding indexing method according to the present embodiment means an indexing method of operating the second table rotation axis 103 and the linear axes and holding the relative position of the tool tip 21a to the workpiece 27. Next, the moving-amount calculation unit 3 calculates the moving amount 15 of each of the second table rotation axis 103 and the linear axes in every predetermined control cycle based on the rotation axis information 11, the rotation direction information 12, the tool relative-position information 13, and the indexing method information 14 (S13). At this time, the moving-amount calculation unit 3 calculates the moving amount 15 such that the tool axis direction 24 matches the positive direction of the Zf-axis of the feature coordinate system 29 while the relative position of the tool tip 21a to the workpiece 27 is held by operating the second table rotation axis 103 and the linear axes.

The position update unit 4 accumulates the moving amount 15 in every predetermined control cycle calculated at S3, and adds the result of accumulation to the tool relative-position information 13 updated in an immediately previous cycle, thereby to update the tool relative-position information 13 (S14). Meanwhile, the moving-amount output unit 5 outputs the position command 17 for each axis to the servo amplifier 50 based on the moving amount 13 calculated at S3 (S15), and the numerical control device 40 then finishes the processing.

On the other hand, when it is determined at S1 that the table 25 and the tool 21 do not become closer to each other, the indexing-method decision unit 2 decides the rotation indexing method (S16). The moving-amount calculation unit 3 calculates the moving amount 15 of the second table rotation axis 103 in every predetermined control cycle based on the rotation axis information 11, the rotation direction information 12, the tool relative-position information 13, and the indexing method information 14 (S17). At this time, the moving-amount calculation unit 3 calculates the moving amount 15 such that the tool axis direction 24 matches the positive direction of the Zf-axis of the feature coordinate system 29 by operating only the second table rotation axis 103. Thereafter, the numerical control device 40 proceeds to S14.

In the second embodiment, description is given for the case where the rotation axis operated at the time of indexing is the second table rotation axis 103, but this is not limitation. However, the rotation axis controlled to operate at the time of indexing is not limited to the second table rotation axis 103. That is, the first table rotation axis 26 may be operated or both the second table rotation axis 103 and the first table rotation axis 26 may be operated.

As described above, according to the second embodiment, it is possible to obtain the numerical control device that selects an appropriate indexing method for avoiding the interference between the workpiece and the tool based on the relative position of the tool to the boundary plane 105. It is thereby possible to achieve advantageous effects equivalent to those of the first embodiment.

### Third Embodiment

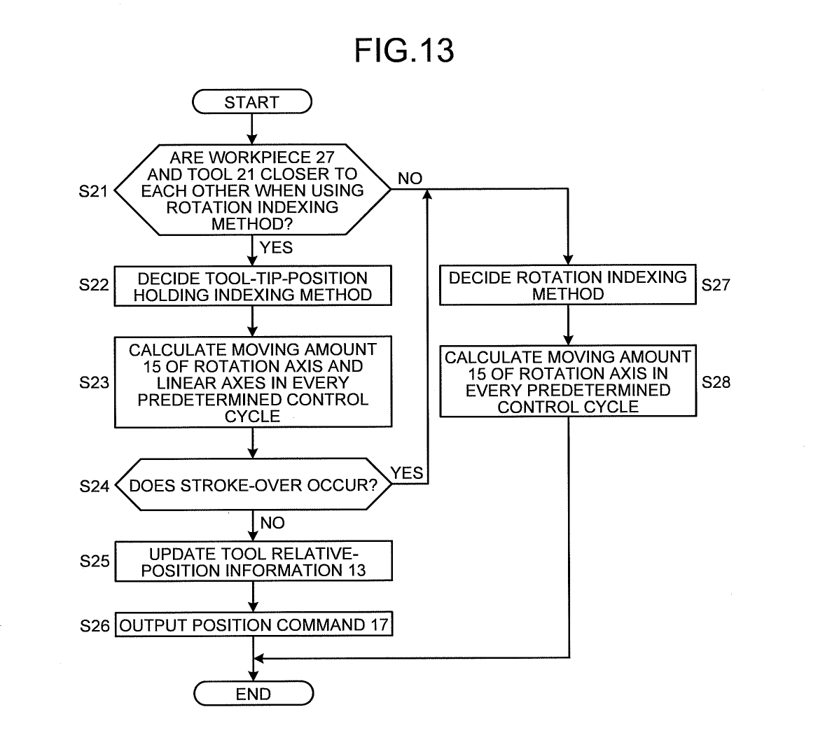

A third embodiment is explained with reference to FIGS. 12 and 13. In the following descriptions, elements different from the first embodiment are mainly explained.

In the tool-tip-position holding indexing method, not only the rotation axis but also the linear axes are operated. This possibly causes a problem that the operations of the linear axes often become excessive and a state (hereinafter, “stroke-over”) where the tool deviates from a movable range occurs, depending on the position of the tool with respect to the workpiece. Conventionally, when stroke-over occurs, it is required to stop an indexing operation and move the position of the tool to fall within the movable range, and to then restart the indexing operation. The third embodiment is intended to avoid the stroke-over without stopping the indexing operation.

FIG. 12 is a functional block diagram showing functions of a numerical control device according to the third embodiment, and corresponds to FIG. 2. The numerical control device 40 according to the third embodiment includes a stroke-over determination unit 6 in addition to the configuration of the first embodiment. Furthermore, a movable range 61 that is a range where the tool tip 21a is allowed to move in each of the linear axis directions of the machine coordinate system 20 is stored in the storage unit 42 shown in FIG. 1. The movable range 61 is defined by setting movable upper-limit coordinates and movable lower-limit coordinates on the linear axes.

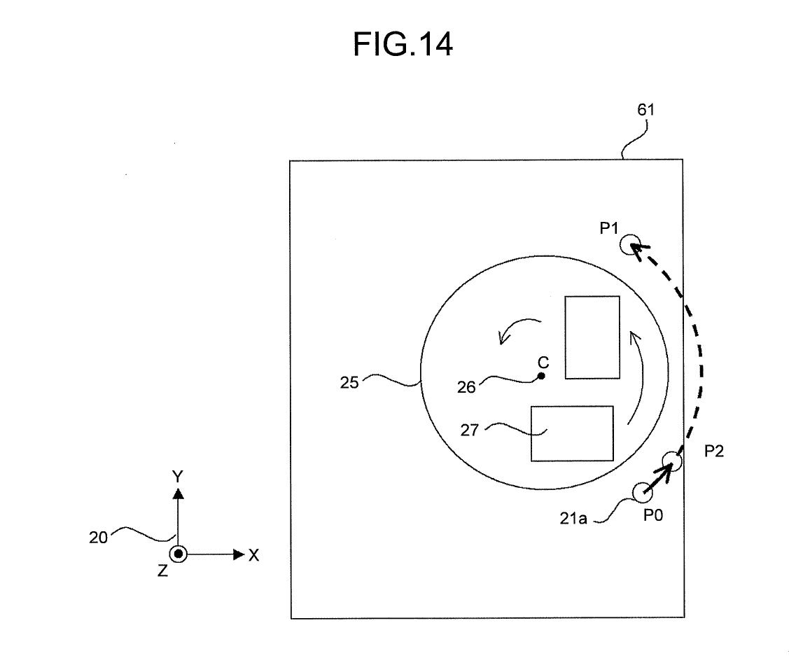

Indexing-related processes performed by the numerical control device 40 are described next with reference to FIGS. 13 and 14. FIG. 13 is a flowchart showing indexing-related processes performed by the numerical control device according to the third embodiment, and corresponds to FIG. 4. S21 to S23 shown in FIG. 13 are equivalent to S1 to S3 shown in FIG. 4, and thus explanations thereof will be omitted.

After S23, the stroke-over determination unit 6 determines whether or not the position of the tool tip 21a in a next control cycle is within the movable range 61, that is, whether or not stroke-over occurs, based on the moving amount 15 in every predetermined control cycle calculated in S23 (S24). When determining at S24 that the position of the tool tip 21a is within the movable range 61 on all the linear axes, that is, when no stroke-over occurs, the stroke-over determination unit 6 sets a stroke-over occurrence signal 16 to be invalid and the numerical control device 40 proceeds to S25. S25 to S28 are equivalent to S4 to S7 shown in FIG. 4, and thus explanations thereof will be omitted.

On the other hand, when determining at S24 that the position of the tool tip 21a in the next control cycle is out of the movable range 61 on any of the linear axes, that is, when stroke-over occurs, the stroke-over determination unit 6 sets the stroke-over occurrence signal 16 to be valid and the numerical control device 40 proceeds to S27. That is, when the stroke-over occurrence signal 16 is valid, the indexing-method decision unit 2 switches the indexing method from the tool-tip-position holding indexing method to the rotation indexing method.

FIG. 14 is an illustration of loci of the tool tip 21a according to the third embodiment. FIG. 14 depicts a case where the table rotation axis 26 and the tool rotation axis 22 are operated as rotation axes to be targeted. A broken line indicates the locus of the tool tip 21a in a case where the tool-tip-position holding indexing method is executed without switching the indexing method. In this case, the tool tip 21a moves from a point P0 to a point P1. A solid line indicates the locus of the tool tip 21a in a case where the indexing method is switched from the tool-tip-position holding indexing method to the rotation indexing method. In this case, the tool tip 21a moves from the point P0 along the locus indicated by the broken line and moves to a point P2 just before deviation from the movable range 61 on the X-axis.

The stroke-over determination unit 6 sets the stroke-over occurrence signal 16 to be valid when the tool tip 21a moves to the point P2. In response to this, the indexing-method decision unit 2 switches the indexing method from the tool-tip-position holding indexing method to the rotation indexing method. As a result, at the point P2, while the moving of the tool 21 in each linear axis direction is stopped, operations of the table rotation axis 26 and the tool rotation axis 22 are continued.

According to the third embodiment, it is possible to achieve an effect of avoiding the stroke-over without stopping the indexing operation by switching the indexing method when the stroke-over occurs on any of the linear axes during the indexing operation in addition to the effects of the first embodiment. This can improve the operation efficiency of an operator of the numerical control device.

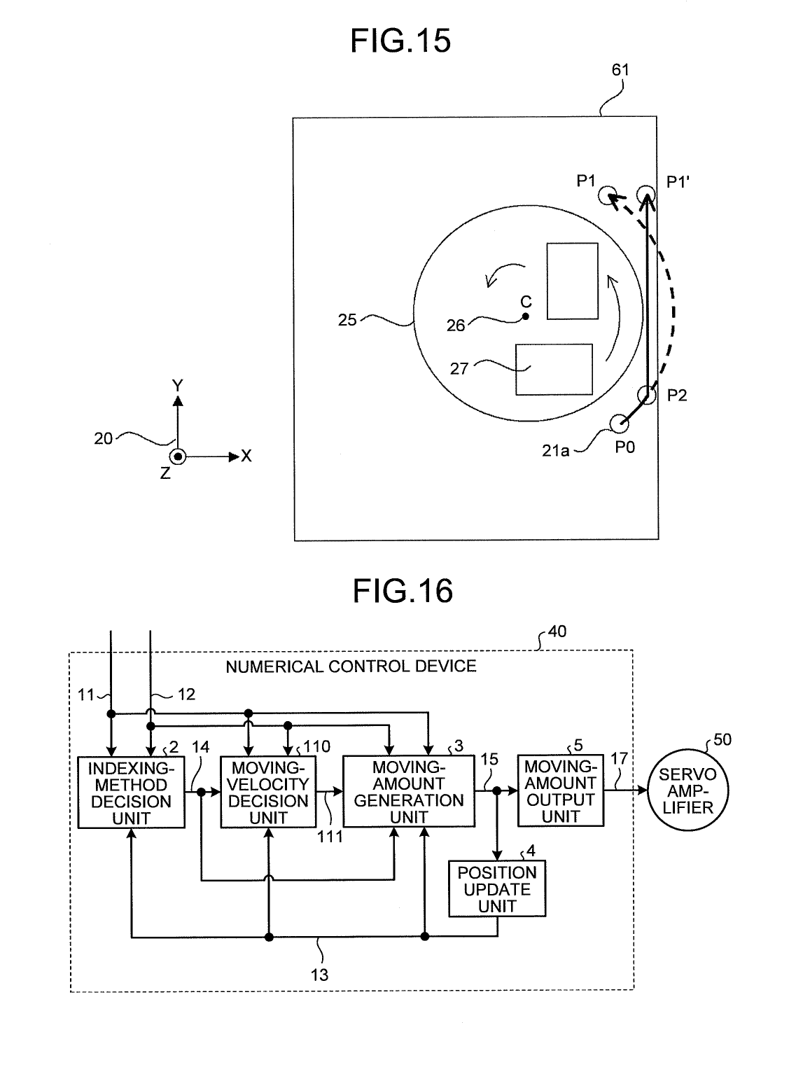

The stroke-over is avoided by switching the indexing method according to the third embodiment, but this is not limitation. FIG. 15 is an illustration of loci of the tool tip 21a according to a development example of the third embodiment. As indicated by a solid line shown in FIG. 15, even in the case where while an operation of a linear axis in which the indexing-method decision unit 2 has determined that stroke-over occurs is stopped, the other linear axis and each rotation axis are continued, it is possible to achieve effects equivalent to those of the third embodiment.

### Fourth Embodiment

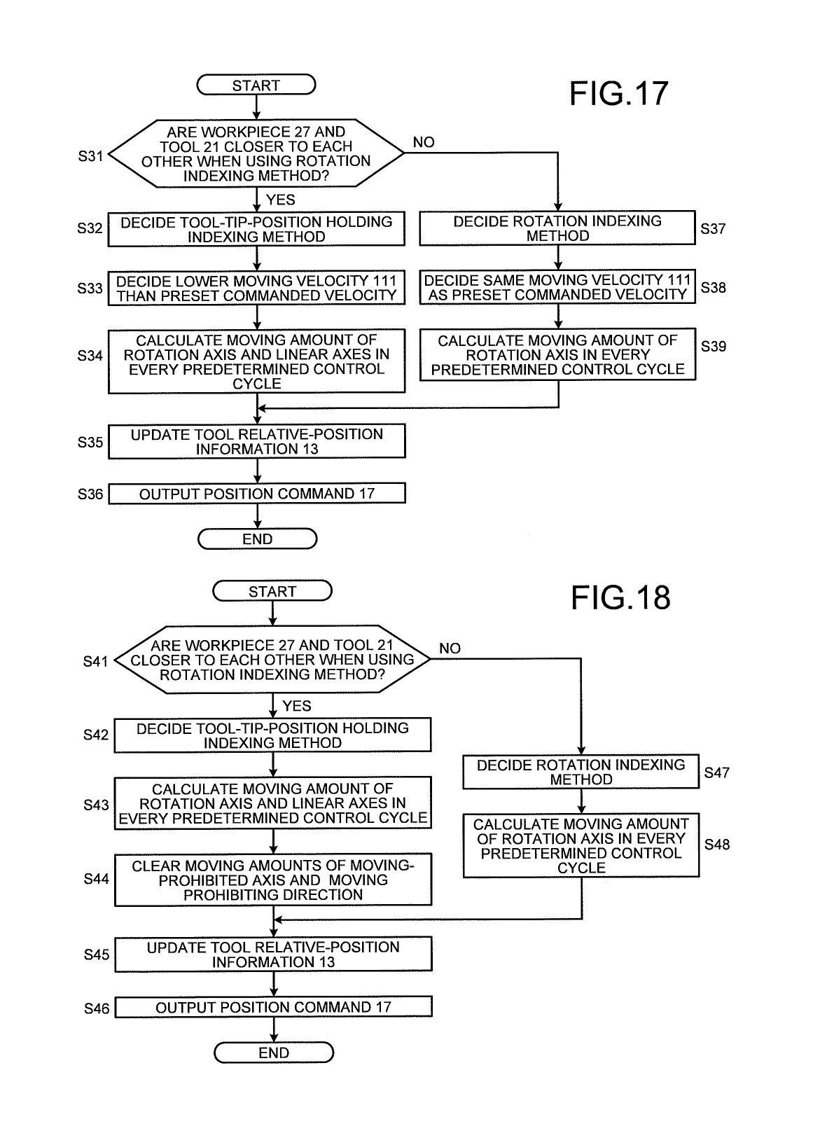

A fourth embodiment is explained with reference to FIGS. 16 and 17. In the following descriptions, elements different from those in the first embodiment are mainly explained.

FIG. 16 is a functional block diagram showing functions of a numerical control device according to the fourth embodiment, and corresponds to FIG. 2. The numerical control device 40 according to the fourth embodiment includes a moving-velocity decision unit 110 in addition to the configuration of the first embodiment.

Indexing-related processes performed by the numerical control device 40 are described next with reference to FIG. 17. FIG. 17 is a flowchart showing indexing-related processes performed by the numerical control device according to the fourth embodiment, and corresponds to FIG. 4. S31 and S32 shown in FIG. 17 are equivalent to S1 and S2 shown in FIG. 4, and thus explanations thereof will be omitted.

After S32, the moving-velocity decision unit 110 decides a lower moving velocity 111 than a preset commanded velocity based on the rotation axis information 11, the rotation direction information 12, the tool relative-position information 13, and the indexing method information 14 (S33). Thereafter, the moving-amount calculation unit 3 calculates the moving amount 15 of each of the rotation axes and the linear axes in every predetermined control cycle based on the rotation axis information 11, the rotation direction information 12, the tool relative-position information 13, the indexing method information 14, and the moving velocity 111 (S34), and the numerical control device 40 proceeds to S35.

S35 to S37 are equivalent to S4 to S6 shown in FIG. 4, and thus explanations thereof will be omitted.

After S37, the moving-velocity decision unit 110 decides the same moving velocity 111 as the preset commanded velocity based on the rotation axis information 11, the rotation direction information 12, the tool relative-position information 13, and the indexing method information 14 (S38). The moving-amount calculation unit 3 calculates the moving amount 15 of each rotation axis in every predetermined control cycle based on the rotation axis information 11, the rotation direction information 12, the tool relative-position information 13, the indexing method information 14, and the moving velocity 111 (S39), and the numerical control device 40 proceeds to S35.

According to the fourth embodiment, it is possible to achieve an effect of decreasing the moving velocity of the tool when the workpiece and the tool become closer to each other during the indexing operation in addition to the effects of the first embodiment. For example, it is thereby possible to avoid the interference between the workpiece and the tool for an operator of the numerical control device to stop the device sufficiently in advance.

The moving velocity is decreased when the workpiece 27 and the tool 21 become closer to each other in the fourth embodiment, but this is not limitation. For example, the moving velocity may be decreased when the length between the workpiece 27 and the tool 21 is smaller than a predetermined length. It is thereby possible to achieve effects equivalent to those of the fourth embodiment.

### Fifth Embodiment

A fifth embodiment is explained with reference to FIGS. 18 to 20. In the following descriptions, elements different from those of the first embodiment are mainly explained.

First, a functional block diagram of the numerical control device 40 according to the fourth embodiment is the same as that shown in FIG. 2 of the first embodiment.

Indexing-related processes performed by the numerical control device 40 are described next with reference to FIG. 18. FIG. 18 is a flowchart showing indexing-related processes performed by the numerical control device 40 according to the fourth embodiment, and corresponds to FIG. 4. S41 to S43 in FIG. 18 are equivalent to S1 to S3 shown in FIG. 4, and thus explanations thereof will be omitted.

After S43, the moving-amount calculation unit 3 clears moving amounts of a preset moving-prohibited axis and a moving prohibiting direction (sets the moving amounts to zero) based on the rotation axis information 11, the rotation direction information 12, the tool relative-position information 13, and the indexing method information 14 (S44).

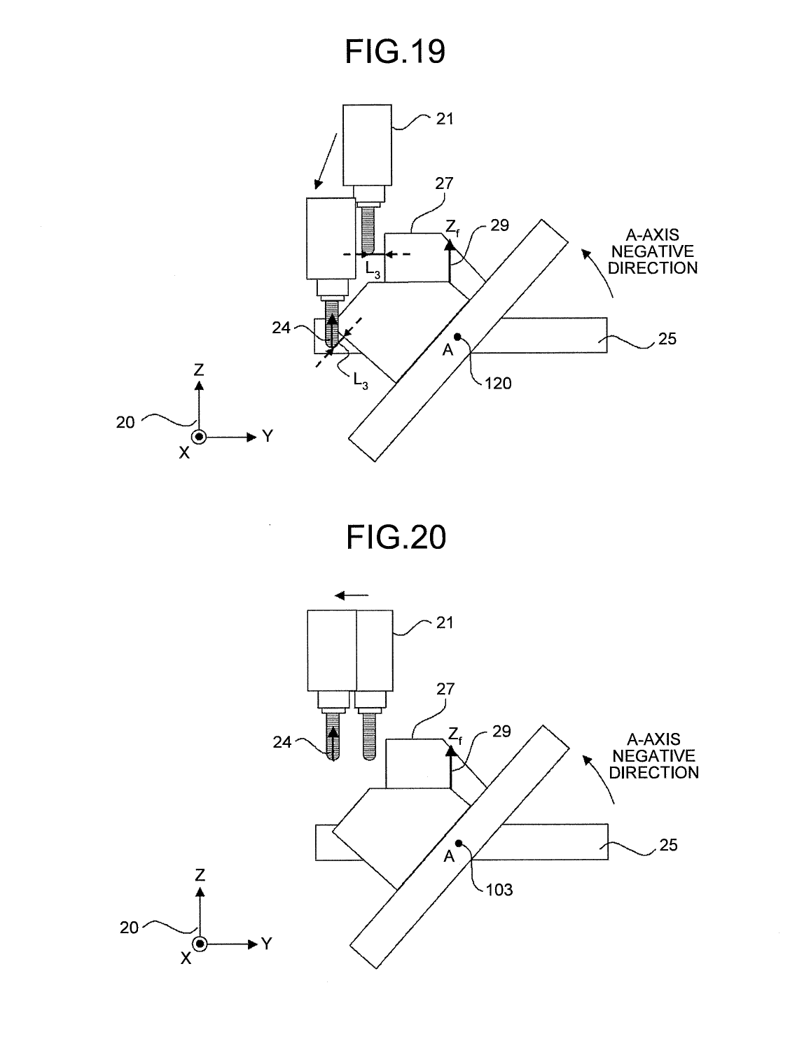

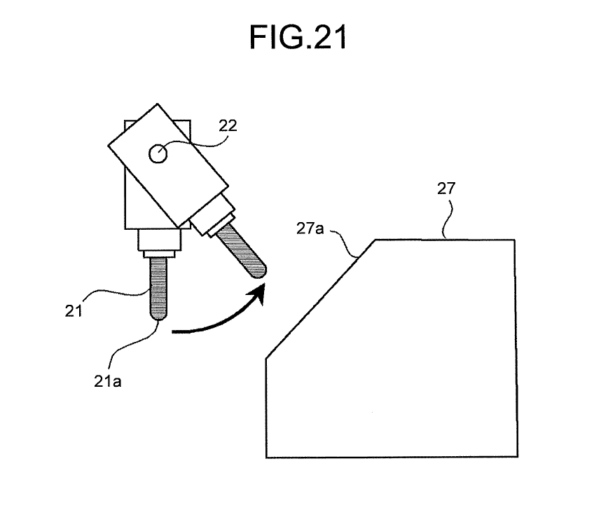

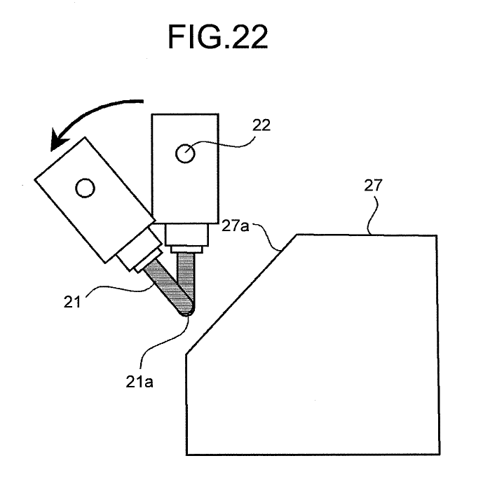

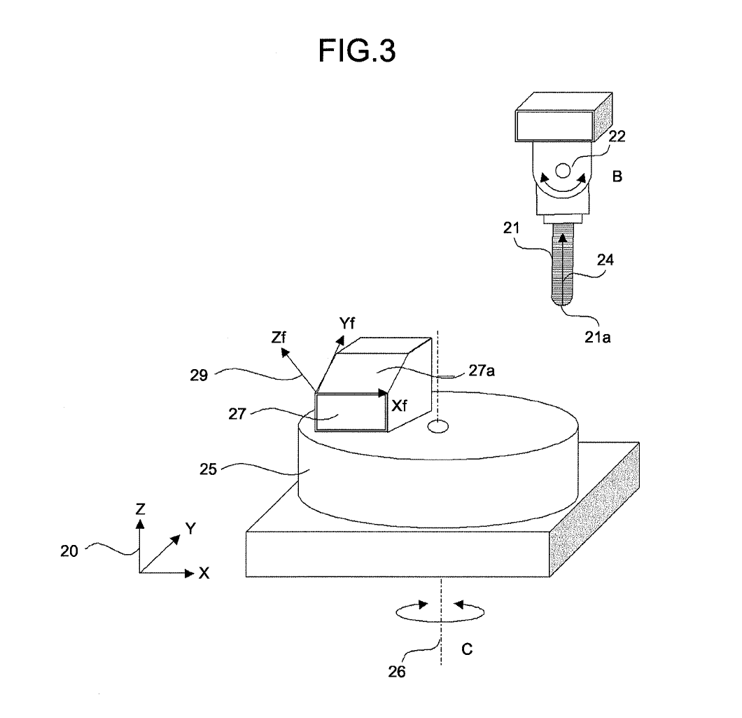

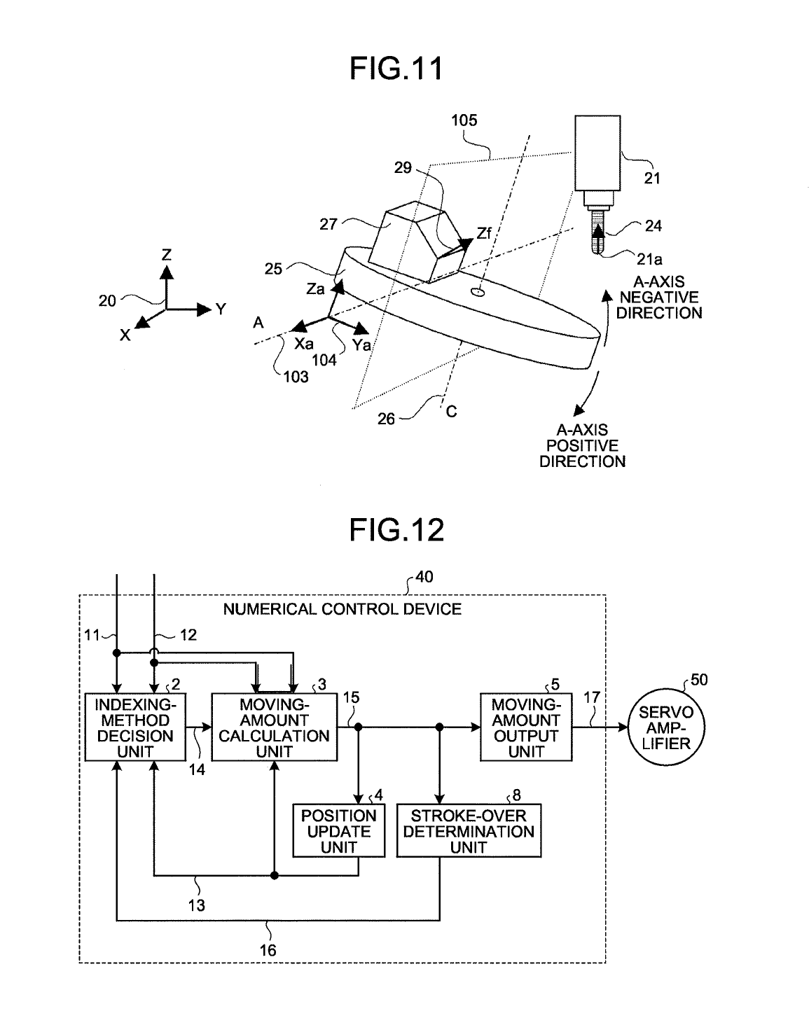

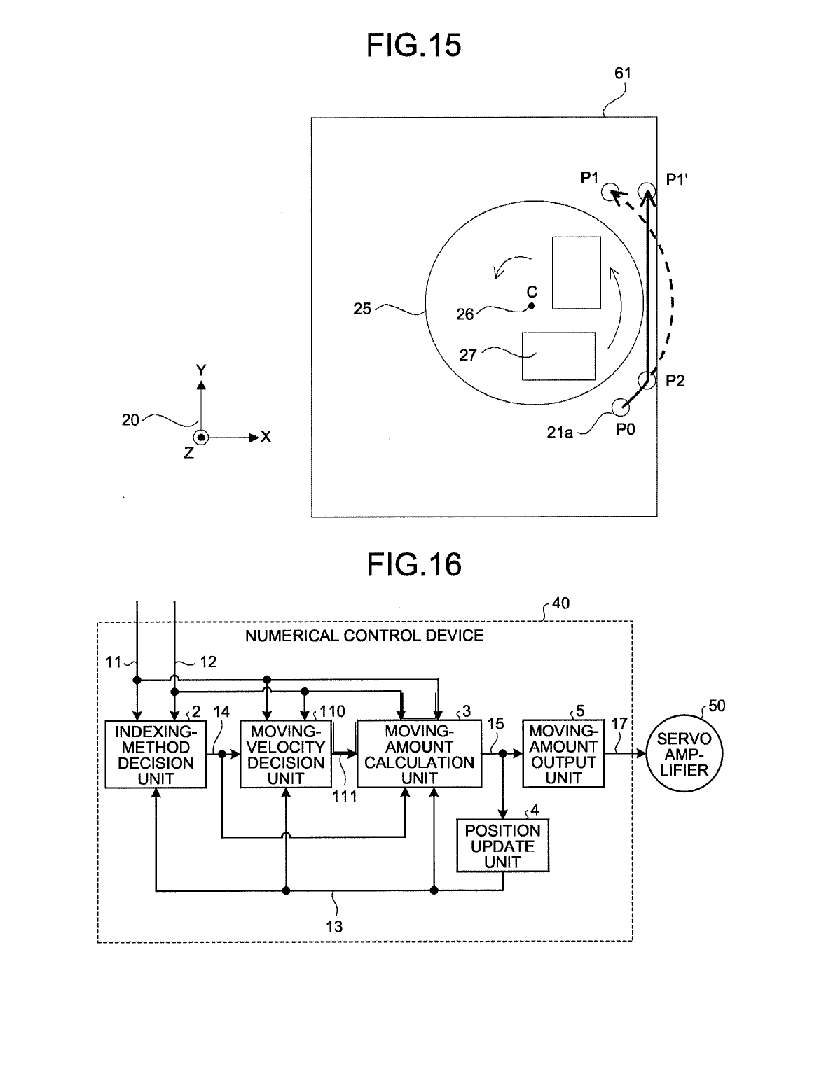

The moving-prohibited axis and the moving prohibiting direction are described while referring to specific examples shown in FIGS. 19 and 20. FIG. 19 depicts a case where the workpiece 25 interferes with the tool 21 when the tool-tip-position holding indexing method is used. FIG. 20 depicts a case where the moving amounts of the moving-prohibited axis and the moving prohibiting direction are cleared in the case of FIG. 19. In the case of FIG. 19, the second table rotation axis 103 that is provided on the table 25 side and that is the A-axis for rotation around the X-axis is rotated in the negative direction (counterclockwise), and the tool 21 is moved in the negative direction of the Y-axis and the negative direction of the Z-axis. It is thereby possible to make the tool axis direction 24 match the positive direction of the Zf-axis of the feature coordinate system 29 while holding the relative position of the tool tip 21a to the workpiece 27, but the tool 21 may interfere with the workpiece 27.

On the other hand, as shown in FIG. 20, it is possible to make the tool axis direction 24 match the positive direction of the Zf-axis of the feature coordinate system 29 and to avoid the interference between the tool 21 and the workpiece 29 by moving the tool 21 not in the negative direction of the Z-axis but only in the negative direction of the Y-axis. Therefore, the moving-prohibited axis is set as the Z-axis and the moving prohibiting direction is set as the negative direction.

As the moving-prohibited axis, any one of the X-axis, the Y-axis and the Z-axis of the machine coordinate system 20 is set. The moving-prohibited axis and the moving prohibiting direction may be set in advance at the time of program analysis or the other time, or may be set based on the indexing method information 14 by a unit (not shown).

S45 to S48 are identical to S4 to S7 shown in FIG. 4, and thus explanations thereof will be omitted.

According to the fifth embodiment, it is possible to achieve an effect of preventing the moving in a predetermined axial direction in addition to the effects of the first embodiment. Therefore, it is possible to avoid the interference between the workpiece and the tool.

1. A numerical control device of a machine tool that includes linear axes and rotation axes, for controlling a position and an attitude of a tool with respect to a workpiece, the numerical control device comprising:
an indexing-method decision unit that decides, as an indexing method, one of a rotation indexing method of operating only the rotation axis and a tool-tip-position holding indexing method of operating the rotation axis and the linear axis and holding a position of a tool tip with respect to the workpiece, based on a commanded rotation axis, a commanded rotation direction of the commanded rotation axis, and the position of the tool;
a moving-amount calculation unit that calculates a moving amount of each of the axes based on the commanded rotation axis, the commanded rotation direction of the commanded rotation axis, the position of the tool, and the indexing method decided by the indexing-method decision unit; and
an output unit that outputs a position command to a servo amplifier based on the moving amount calculated by the moving-amount calculation unit.

2. The numerical control device according to claim 1, wherein the indexing-method decision unit determines whether or not the workpiece or a table becomes closer to the tool when performing indexing in the rotation indexing method, decides the rotation indexing method as the indexing method when determining that the workpiece or the table does not become closer to the tool, and decides the tool-tip-position holding indexing method as the indexing method when determining that the workpiece or the table becomes closer to the tool.

3. The numerical control device according to claim 2, wherein the indexing-method decision unit determines whether or not the workpiece becomes closer to the tool when performing the indexing in the rotation indexing method based on change in a length between the workpiece and the tool tip before and after rotation of the rotation axis.

4. The numerical control device according to claim 2, wherein the indexing-method decision unit determines whether or not the table becomes closer to the tool when performing the indexing in the rotation indexing method, based on the commanded rotation direction of the table rotation axis and the position of the tool with respect to a boundary plane that contains the table rotation axis and that is orthogonal to an upper surface of the table, if the commanded rotation axis is equal to the table rotation axis parallel to the upper surface of the table.

5. The numerical control device according to claim 1, comprising a stroke-over determination unit that determines whether or not each linear axis is out of a movable range when each linear axis moves by as much as the moving amount calculated by the moving-amount calculation unit, based on the moving amount and the movable range, the movable range being defined in advance to be a range in which each linear axis is allowed to move, wherein
the indexing-method decision unit switches the indexing method to the rotation indexing method when the stroke-over determination unit determines that any of the linear axes becomes out of the movable range when the linear axis moves by as much as the moving amount after deciding the tool-tip-position holding indexing method as the indexing method.

6. The numerical control device according to claim 1, comprising a moving-velocity decision unit that decides a lower moving velocity than a commanded velocity when the indexing-method decision unit decides the tool-tip-position holding indexing method as the indexing method, wherein
the moving-amount calculation unit calculates the moving amount of each of the axes based on the commanded rotation axis, the commanded rotation direction of the commanded rotation axis, the position of the tool, the indexing method decided by the indexing-method decision unit, and the moving velocity decided by the moving-velocity decision unit.

7. The numerical control device according to claim 1, wherein
the moving-amount calculation unit calculates a second moving amount by clearing the moving amount of a predetermined linear axis and the moving amount in a predetermined linear axis direction after calculating the moving amount when the indexing-method decision unit decides the tool-tip-position holding indexing method as the indexing method, and
the output unit outputs the position command to the servo amplifier based on the second moving amount calculated by the moving-amount calculation unit.

8. A numerical control method for a numerical control device of a machine tool that includes linear axes and rotation axes for controlling a position and an attitude of a tool with respect to a workpiece, the numerical control method comprising:
a determining step of determining whether or not the workpiece or a table becomes closer to the tool when indexing is performed in a rotation indexing method of operating only the rotation axes; and
an indexing step of performing indexing in the rotation indexing method when it is determined at the determining step that the workpiece or the table does not become closer to the tool, and performing indexing in a tool-tip-position holding indexing method of operating the rotation axis and the linear axis and holding a position of a tool tip with respect to the workpiece when it is determined at the determining step that the workpiece or the table becomes closer to the tool.

9. The numerical control method according to claim 8, comprising:
a stroke-over determining step of determining whether or not each of the linear axes is out of a movable range, the moving range being defined in advance to be a range in which each of the linear axes is allowed to move; and
a switching step of switching an indexing method to the rotation indexing method when the indexing is performed in the tool-tip-position holding indexing method and it is determined at the stroke-limit determining step that any of the linear axes is out of the movable range when the linear axis moves by as much as the moving amount.

10. The numerical control method according to claim 8, wherein a velocity of the tool with respect to the workpiece is made lower than a commanded velocity when the indexing is performed in the tool-tip-position holding indexing method.

11. The numerical control device according to claim 2, comprising a stroke-limit determination unit that determines whether or not each linear axis is out of a movable range when each linear axis moves by as much as the moving amount calculated by the moving-amount calculation unit, based on the moving amount and the movable range, the movable range being defined in advance to be a range in which each linear axis is allowed to move, wherein
the indexing-method decision unit switches the indexing method to the rotation indexing method when the stroke-limit determination unit determines that any of the linear axes becomes out of the movable range when the linear axis moves by as much as the moving amount after deciding the tool-tip-position holding indexing method as the indexing method.

12. The numerical control device according to claim 3, comprising a stroke-limit determination unit that determines whether or not each linear axis is out of a movable range when each linear axis moves by as much as the moving amount calculated by the moving-amount calculation unit, based on the moving amount and the movable range, the movable range being defined in advance to be a range in which each linear axis is allowed to move, wherein
the indexing-method decision unit switches the indexing method to the rotation indexing method when the stroke-limit determination unit determines that any of the linear axes becomes out of the movable range when the linear axis moves by as much as the moving amount after deciding the tool-tip-position holding indexing method as the indexing method.

13. The numerical control device according to claim 4, comprising a stroke-limit determination unit that determines whether or not each linear axis is out of a movable range when each linear axis moves by as much as the moving amount calculated by the moving-amount calculation unit, based on the moving amount and the movable range, the movable range being defined in advance to be a range in which each linear axis is allowed to move, wherein
the indexing-method decision unit switches the indexing method to the rotation indexing method when the stroke-limit determination unit determines that any of the linear axes becomes out of the movable range when the linear axis moves by as much as the moving amount after deciding the tool-tip-position holding indexing method as the indexing method.
